(19) United States
(12) Patent Application Publication
(10) Pub. No.: US 2003/0120707 A1
(43) Pub. Date: Jun. 26, 2003

(54) Systems and methods for exporting functionality of a modularized system

(76) Inventors: Sander Bogdan, Redmond, WA (US); Keith C. Bentley, Kirkland, WA (US)

Correspondence Address: LEE & HAYES PLLC, 421 W RIVERSIDE AVENUE SUITE 500, SPOKANE, WA, 99201

(21) Appl. No.: 10/028,739

(22) Filed: Dec. 21, 2001

(51) Int. Cl. G06F 9/00; G06F 9/44

(52) U.S. Cl. 709/106; 717/108

(57) ABSTRACT

Systems and methods are described herein for exporting the functionality of a modularized system. In addition to the computer-executable components of the modularized system, a software development kit (SDK) that may include the modularized system components also must contain development files that allow a user to work with the modularized system and develop applications for use with the modularized system. Development files may include header files, library files, documentation files, auxiliary files, and the like. Data objects corresponding to source operating system features are created and include reference to SDK objects that correspond with development files. When a subset of the features is selected, the data objects are used to locate SDK objects that are used to determine the development files to include in the modularized system. From the selected SDK objects, appropriate development files are selected for exporting with an SDK to allow a user to access the functionality of the modularized system.

### TECHNICAL FIELD

The systems and methods described herein generally relate to exporting the functionality of a modularized system. More particularly the systems and methods described herein relate to building a target computer operating system from a set of source operating system components and exporting the functionality of the target operating system.

### BACKGROUND

An embedded or appliance computing device typically provides a smaller set of features compared to a general-purpose computer. For such devices, it is desired that a more compact operating system, tailored to the defined set of features be used, as opposed to using a general-purpose operating system. Although conventional comprehensive operating systems can be used to drive such embedded/appliance devices, providing the memory and processing power for such operating systems burdens the device manufacturers with expensive overhead that is unnecessary for their product. An ideal solution would be to allow manufacturers of special purpose electronic devices to choose desired features from a comprehensive source operating system to include in a target operating system, and then to build the target operating system that provides only those features that have been chosen. Doing so would allow the device to be smaller and less expensive, thereby making the device more attractive to consumers.

The problem with such a solution, however, is that operating systems are complex programs comprised of a multitude of components. Some components export data or functionality to other components. Some components cannot function properly unless other components are present to provide data or functionality to them. In addition, features of an operating system typically do not map directly to the various components of the operating system. These interdependencies among components of an operating system and the fact that operating system features do not map directly to operating system components provide an obstacle to building a target operating system simply by first selecting features from a source operating system and then building the target operating system from the source operating system based on the selected features. Typically, implementation of a particular feature of an operating system depends on more than one component of the operating system. Furthermore, one component may be required by more than one feature.

Therefore, given a subset of all the features of a source operating system, there is a problem of how to select an appropriate set of operating system components that are necessary to implement the desired feature subset in a target operating system. Furthermore, once the components of the target operating system have been identified, there is the additional problem of exporting the functionality of the target operating system to enable developers to develop applications for use with the target operating system.

This particular problem was addressed in U.S. patent application Ser. No. 09/883,120, entitled, “System and Method For Building A Target Operating System From A Source Operating System,” filed Jun. 15, 2001 by the present Applicants and assigned to MICROSOFT CORPORATION.

An additional problem that remains is that, once the target operating system is built, i.e., the functional components of the target operating system are identified and selected, the functionality of the target operating system must still be exported—usually with additional components—so that applications may be developed to run on the target operating system. Additional components—hereafter referred to as development files—that are typically associated with such an operating system include, but are not limited to, library files, documentation files, header files, auxiliary files, and the like. It is desirable to receive an operating system together with a package that includes the development files to enable a user to run the target operating system and to develop applications that utilize the target operating system.

### SUMMARY

Methods and systems are described that enable building a modularized system and exporting the functionality of the system. The exporting may be practiced together with or separate from the system building and each is explained herein. In describing the building of a modularized system, methods and systems are described that provide for selection of an appropriate set of components from a source operating system to build a target operating system according to a particular subset of features from the source operating system that is to be provided by the target operating system. In building the target operating system from the source operating system, the appropriate set of components are first selected from the source operating system and are then properly linked to provide the target operating system.

More specifically, in one implementation described herein, each object of a source operating system is represented as a data object that has the following attributes (as used herein, an object refers to (1) a component of the operating system, or (2) a set of components of the operating system that operate to provide a particular feature of the operating system):

1) Name;

2) Type;

3) Exports;

4) Hard References;

5) Soft References; and

6) Independent Links.

A Name and Type are used to uniquely identify the data object. Exports are the data provided by this data object to other data objects. A data object may have from zero to literally hundreds or more of Exports.

References are further identified as Hard References or Soft References. A Hard Reference is a critical Reference (for example, but not limited to, data to be received by this data object from another data object) that must be resolved for a feature provided by this data object to function properly. Conversely, a Soft Reference is a non-critical Reference that is not required to be resolved for the feature provided by this data object to function properly. Identification of Soft References is used to identify the components from the source operating system that may be omitted when building the target operating system.

An Independent Link is a set of Exports and References that are not merged into the Exports and References of its containing data object. For example, an API (application programming interface) set function table lists every function that is available in the API set. The table itself is contained in one component but references many other objects. Using only the Export and Reference attributes of the containing data object would cause every component referenced in the table to be selected. In this case, Independent Links are used in the containing data object to identify the table entries as independent Exports and References. Using Independent Links, the table entries can be exported or referenced independently of one another.

Independent Links are also used in order to model choices that need to be made when selecting the desired features to be used in the target operating system. This is described in greater detail below.

After data objects representing the components of the source operating system are created, a master dependency graph is constructed by connecting each Reference to the Export that resolves the Reference. Features required by the target operating system are then selected. Beginning with the selected features, links in the dependency graph are traced and components that are encountered are marked to be included in the target operating system. After the links have been traversed, the marked components are combined to create the target operating system. The target operating system is a system of components, or modules, and therefore may be referred to as a modularized system. As such, reference hereinafter may simply be made to a modularized system. As defined herein, a modularized system includes a target operating system constructed from components of a source operating system as described herein.

The claims define systems and methods that provide for exporting the functionality of the modularized system once the modularized system is built. The final exportable unit will be referred to as a software development kit, or SDK. An SDK includes, at a minimum, one or more development files that are required to support the modularized system. Development files may include header files, library files, documentation files, auxiliary files, and the like. Development files enable a developer to develop applications to run on or with the target operating system. It is noted that the SDK may also include the modularized system. Although the following discussion will refer to an SDK as including the modularized system, it is noted that the SDK may typically exclude the modularized system. For example, an SDK for a PDA (Personal Digital Assistant) does not typically include the PDA operating system (i.e., target operating system or modularized system). Instead, the modularized system exists on the PDA and an SDK that does not include the modularized system is delivered separately to developers.

An SDK object similar to a data object described above is created for each component of the source operating system that exposes a feature or function to a developer, i.e., that requires an SDK component. Specifically, an SDK object is a data object of type “SDK” that includes a name and is of a particular type (e.g., type SDK). A first SDK object may also include a reference to one or more other SDK objects that are required to support the first SDK object. In addition, an SDK object may include an export list that identifies each function that may be exposed by the SDK object.

In one implementation, a user selects features from a source operating system that the user wishes to include in a target operating system. Each selectable feature has an SDK object associated with it. Selecting the feature causes the associated SDK object to be selected. Similarly to the process described for building the target operating system, references in the selected SDK objects are traced to locate other SDK objects, which are also selected. References of the newly selected SDK objects are traced, and so on, until all the references have been resolved to an SDK object.

After the tracing has been completed to select the appropriate SDK objects, an SDK header file is created that can be utilized to build a linked library or executable of development files that can be used with the modularized system to create applications for the modularized system. The SDK header file may be constructed either by generating the SDK header file or by filtering a master SDK header file.

In generating the SDK header file, each function exposed by an SDK object is examined. If a function is exposed and the function is included in the modularized operating system, language is appended to the SDK header file to include the development file(s) associated with the export. This is done for all exports in the export list of each SDK object until a complete SDK header file is created. The SDK header is utilized to pull in each appropriate development file to a final SDK.

In filtering a master SDK file to create the SDK header file, the master SDK file contains code language that exposes each development file if one or more conditions are met. The master SDK file is executed to pull in each appropriate developmental file to a final SDK.

In another implementation, data objects associated with each feature include references to SDK objects as well. In such an implementation, SDK objects directly associated with the features are unnecessary. When the features are selected, the SDK objects are traced (beginning with SDK object references in the data objects associated with the selected features) and selected until all appropriate SDK objects have been selected. Once all the SDK objects have been selected, a final SDK can be built that includes the modularized system and all necessary development files to create applications for the modularized system.

The final SDK includes the supporting development files and may optionally include the final modularized system constructed from the source operating system. The development files (and, possibly, the modularized system) may then be stored on one or more computer-readable media for easy distribution to customers.

This summary itself is not intended to limit the scope of this patent. For a better understanding of the present invention, reference should be made to the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a block diagram of a static library and the components thereof.

FIG. 2 is a block diagram of a static library and the components thereof, including a reference table.

FIG. 3 is an illustration of a data object shown in accordance with the present invention.

FIG. 4 is a block diagram of a system in which the present invention may be implemented.

FIG. 5 is a flow diagram showing a methodological implementation of the system of FIG. 4.

FIG. 6 is a block diagram depicting an exemplary system for creating a modularized system and exporting the functionality of the modularized system.

FIG. 7 is an illustration of an exemplary SDK object shown in accordance with one or more embodiments and/or implementations shown here.

FIG. 8 is a flow diagram depicting a methodological implementation of exporting the functionality of a modularized system.

FIG. 9 is an example of a computing operating environment capable of implementing the present invention claimed herein.

FIG. 10 is a block diagram of an exemplary system for exporting the functionality of a modularized system.

### DETAILED DESCRIPTION

The following description of systems and methods for exporting functionality of a modularized system incorporates systems and methods previously described in U.S. patent application Ser. No. 09/883,120, entitled, “System and Method For Building A Target Operating System From A Source Operating System,” filed Jun. 15, 2001 by the present Applicants and assigned to MICROSOFT CORPORATION. That patent application is hereby incorporated by reference.

The following description sets forth one or more specific embodiments of systems and methods that utilize dependency modeling to provide a way to build a target operating system (i.e., a modularized system) from a source operating system, as well as systems and methods for exporting the functionality of the modularized system. The systems and methods for exporting the functionality of the modularized system incorporate elements recited in the appended claims. These implementations are described with specificity in order to meet statutory written description, enablement, and best-mode requirements. However, the description itself is not intended to limit the scope of this patent.

Also described herein are one or more exemplary implementations of systems and methods that utilize dependency modeling to provide a way to build a target operating (modularized) system from a source operating system, and systems and methods for exporting the functionality of the modularized system. Applicants intend these exemplary implementations to be examples only. Applicants do not intend these exemplary implementations to limit the scope of the claimed present invention. Rather, Applicants have contemplated that the claimed present invention might also be embodied and implemented in other ways, in conjunction with other present or future technologies.

### I. Building a Target Operating System from a Source Operating System

A. Introduction

The dependency modeling discussed herein will be described with reference to an operating system that is built as a number of static libraries. More particularly, the present discussion will focus on and use the WINDOWS CE operating system produced by MICROSOFT CORP. as an example. Although other operating systems may or may not exhibit the same or similar features, characteristics or behavior as the WINDOWS CE operating system, it will be clear to those skilled in the art that the dependency modeling described herein may be applied with other operating systems to model dependencies and, as a result, build target operating systems that are a subset of the components of a source operating system. Use of the WINDOWS CE operating system as an example to describe the present invention is not intended to limit the scope of the appended claims to a particular operating system.

As previously stated, the WINDOWS CE operating system is built as a number of static libraries. Each static library is constructed by compiling one or more source code files into object files and then linking the object files to form the static library. Each source file, when compiled and operating in a computer, provides one or more functions, each function referencing from zero to several other functions.

B. Static Library And Components

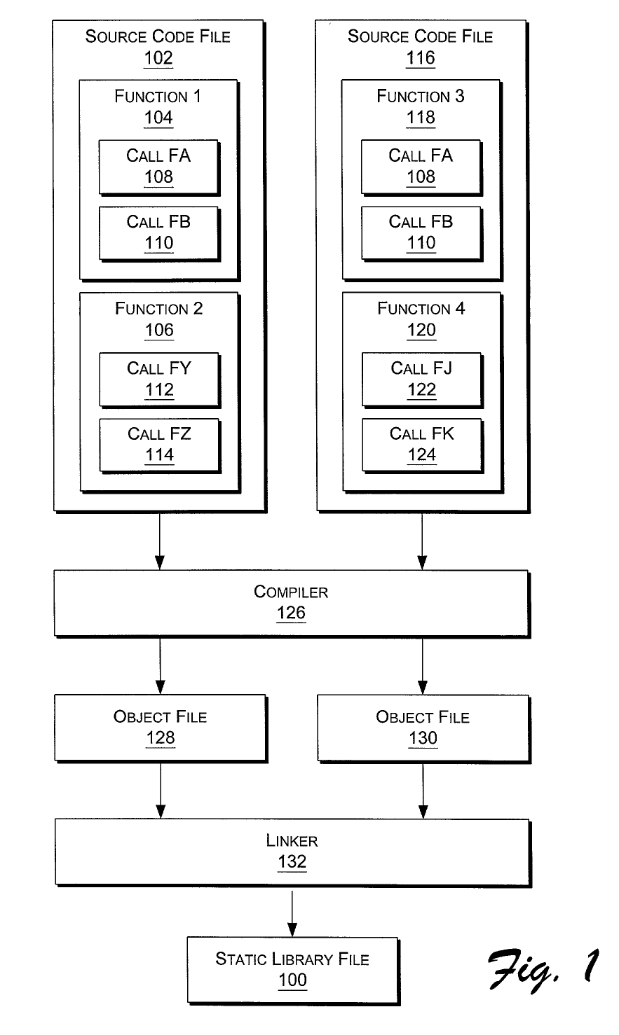

FIG. 1 is a simplified block diagram of a static library 100 and components that are utilized in building the static library 100. Source code file 102 includes Function 1 104 and Function 2 106. Function 1 104 references Function A 108 and Function B 110. Function 2 106 references Function Y 112 and Function Z 114. Source code file 116 includes Function 3 118 and Function 4 120. Function 3 118 references Function A 108 and Function B 110. Function 4 120 references Function J 122 and Function K 124.

Source code file 102 and source code file 116 are compiled by compiler 126 to form object file 128 and object file 130, respectively. Object file 128 contains encoded information about Function 1 104 and Function 2 106. Object file 130 contains encoded information about Function 3 118 and Function 4 120. Object file 128 and object file 130 are linked by linker 132 to form the static library 100. The static library 100 thereby contains encoded information from object file 128 and object file 130. The static library 100 is used in a source operating system (not shown).

It can be seen that the Export and Reference information from the individual source files 102, 116 is merged into the static library 100. This is similar to how the linker 132 arranges information in the static library 100.

C. Dependency Modeling

For dependency modeling, each of several static libraries in a source operating system has a corresponding Export/Reference data object associated therewith. The information contained in the data objects can be used to identify the other data objects that are necessary to support particular features of an operating system.

The determination of which components of a source operating system are required to build a target operating system with particular features of the source operating system is accomplished in three basic steps: construction, connection and selection.

A data object describing Export and/or Reference information for a component is first constructed for each component of the source operating system. It is noted that, although the present discussion will focus on a component as being a static library, in general a component may be any section of code, object, or container that can be separated from other code without undue burden. Data objects are also constructed for the features of the operating system.

Next, a master dependency graph, or model, is constructed by connecting each Reference to an Export that resolves the Reference. Finally, starting from desired components, functions, or a combination of desired components and function that are required by the user, the dependency model is traced to select the components (for example, static libraries in the case of Windows CE) that are required to build the desired target operating system that contains a subset of the features of the source operating system.

A problem with the simple model suggested above is that it will almost always result in selection of all the components from the source operating system because selection of one static library will result in identification of References that can only be resolved by selection of more static libraries until, eventually, all static libraries are selected. This problem is resolved with the introduction of Soft References and “Choice” data objects. Soft References are non-critical References, i.e., References that do not have to be resolved to have a working, albeit functionally reduced, system. Soft References—which will be described in more detail below—are the basic mechanism by which source operating system components can be omitted from the target operating system. When necessary, References will be described as either Hard References or Soft References.

D. Choice Objects

One problem that arises when constructing a dependency graph is when alternative options are provided for a feature. For example, some devices may have a mouse while other devices may have a touch screen. The source operating system includes a mouse cursor and a touch screen cursor, but each target operating system may require one or the other. On devices that have a mouse, a mouse cursor would be chosen to configure the target operating system. On devices that have a touch screen, a touch screen cursor would be used. A dependency graph cannot be completed until it is known which option will be required by the target operating system.

For such cases, provision is made for alternative options by referencing the alternatives in a data object of type “Choice.” A “Choice” data object allows alternative configurations to be modeled prior to the configuration of the system, thereby allowing a complete dependency model to be constructed before one or more alternative choices must be made for a particular configuration.

To accomplish this, the alternative options are made Independent Links in the “Choice” data object. In such an implementation, the Exports of the respective choices are made the Exports of the “Choice” data object. (The References will be the same for each alternative). Explicitly modeling the choice allows the construction of a dependency model of the entire system independently of the features selected by the user.

E. Soft References

To explain Soft References more fully, assume in the present example that neither Function K 124 nor Function Z 114 are critical requirements for functionality of the static library 100. In such a circumstance, Function K 124 and Function Z 114 would be identified as non-critical components in the construction and/or connection phase, and those functions would not be selected in the selection phase to be included in the target operating system.

A more concrete example is found in the WINDOWS CE operating system. In this operating system, which can be used as a source operating system to build a target operating system, the system objects (known as “windows”) serve a dual purpose. They provide a mechanism to display graphics externally on a computer monitor and they provide a destination for messages to be sent when writing programs to run on the operating system. Some products do not need the graphics capability of the operating system, and a device manufacturer may prefer to leave it out of the target operating system since it would not be used. More specifically, the source code to create a window makes a specific call to the graphics subsystem, GweNewGdiWindow, to notify it when a window is created. If this call were a Hard Reference, the graphics subsystem would always be pulled into the final configuration of the target operating system. By designating this call a Soft Reference, the code for the graphics subsystem will not be pulled into the final configuration of a target operating system just because windows code is being used in the target operating system.

While this solution solves the problem of how to identify components to leave out of a target operating system, another problem arises due to the fact that there are a number of places in an operating system that contain what are essentially renaming tables. For example, an API (application programming interface) set function table lists every function that is available in the API set. The table itself is contained in one component but references objects in many other components. Using the simple scheme described above to merge the References causes problems. Leaving the function References as Hard References will cause every component to be pulled into the target operating system, which is not the desired behavior. On the other hand, designating those References as Soft References is not appropriate since the functions do need to be in the target operating system if they are needed.

The concept of Independent Links, described above, is used to solve this particular problem. The solution to this problem is to refrain from merging the information in the table into the rest of the Exports and References of the data object. The Export/Reference links in the table remain independent.

F. Source Code File And Components

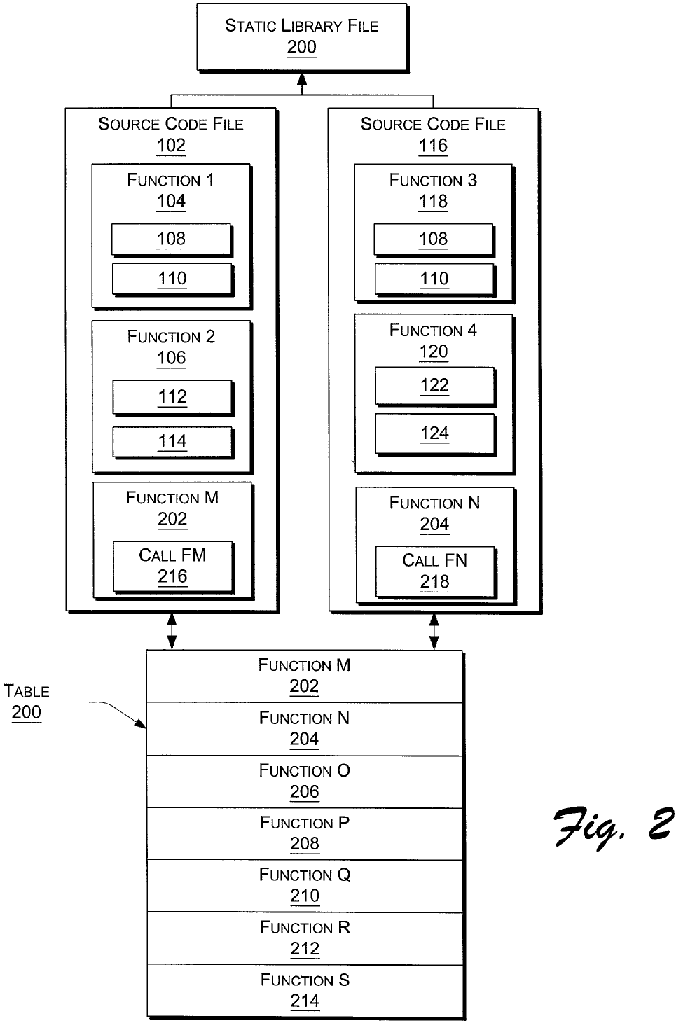

FIG. 2 is a block diagram of source code file 102 and its components, and source code file 116 and its components from FIG. 1. In addition, FIG. 2 shows a table 200 having several entries: Function M 202, Function N 204, Function 0 206, Function P 208, Function Q 210, Function R 212, and Function S 214. Source code file 102 includes Function M 202 that includes a call 216 to the Function M 202 entry of the table 200. Source code file 116 includes Function N 204 that includes a call 218 to the Function N 204 of the table 200. Source code file 102 and source code file 116 are compiled and linked to create static library 220.

According to the present invention, only the specific entries (Function M 202 and Function N 204) are selected from the table, rather than selecting all the functions (202-214) in the table. This significantly reduces the size of the target operating system. The use of Independent Links will be described in greater detail below, with continuing reference to the remaining figures.

G. Exemplary Data Structure: Data Object

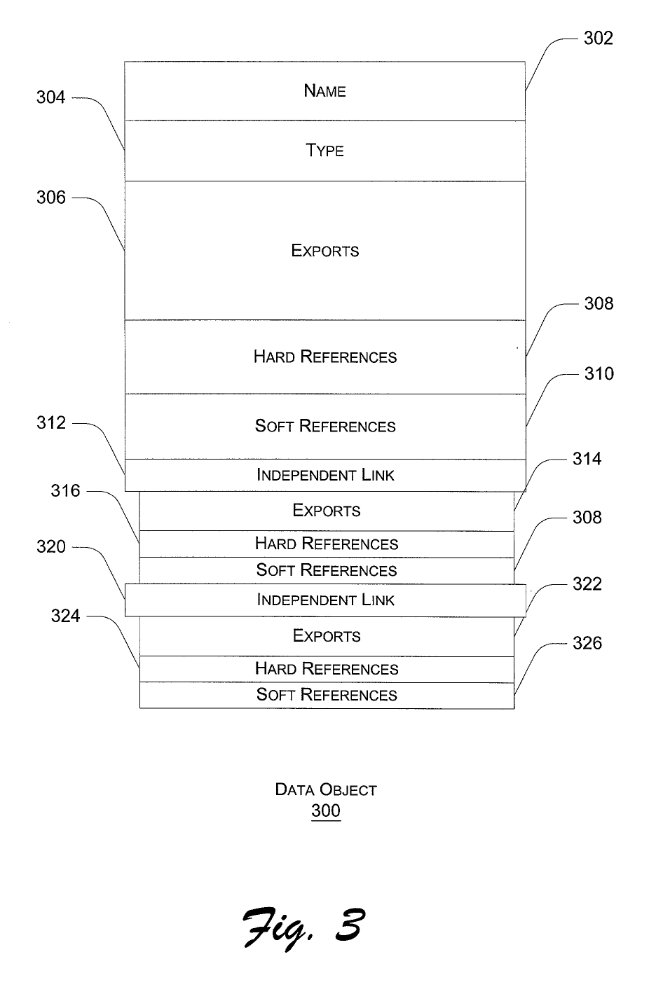

FIG. 3 is a block diagram depicting a data structure that can be used to represent a source operating system component. Shown in FIG. 3 is a data object 300 having a Name field 302 and a Type field 304. The data object 300 also includes an Exports field 306, a Hard References field 308 and a Soft References field 310. The Exports field 306 may contain from zero to hundreds of members to indicate data output by the source operating system component represented by the data object 300. Likewise, the Hard References field 308 and the Soft References field may contain from zero to hundreds of members to indicate data referenced by the source operating system component represented by the data object 300.

The data object 300 is shown with a first Independent Link 312, which has an Exports field 314, a Hard References field 316 and a Soft References field 318. The data object 300 also includes a second Independent Link 320, which has an Exports field 322, a Hard References field 324 and a Soft References field 326.

Referring back to FIG. 2, a data object constructed to represent static library 200 would be represented according to data object 300 as follows:

Name (302): Component
Type (304): Static Library
Exports (306):

Function 1
Function 2
Function 3
Function 4

Hard References (308):

Function A
Function B
Function Y
Function J

Soft References (310):

Function K
Function Z

Independent Link (312):

Exports (314):

API Entry M

Hard References (316):

Function M

Independent Link (320):

Exports (322):

API Entry N

Soft References (324):

Function N
(Note that, for exemplary purposes only, Function M is a Hard Reference and Function N is a Soft Reference).

The data objects that represent source operating system components and features may be constructed in any practical manner including, but not limited to, manually creating the data objects, using existing information derived from software tools to automatically create the data objects, etc. How the data objects are created is not the focus of the present application, only that they are created to represent features and components of the source operating system.

H. Exemplary Target Operating System Building System

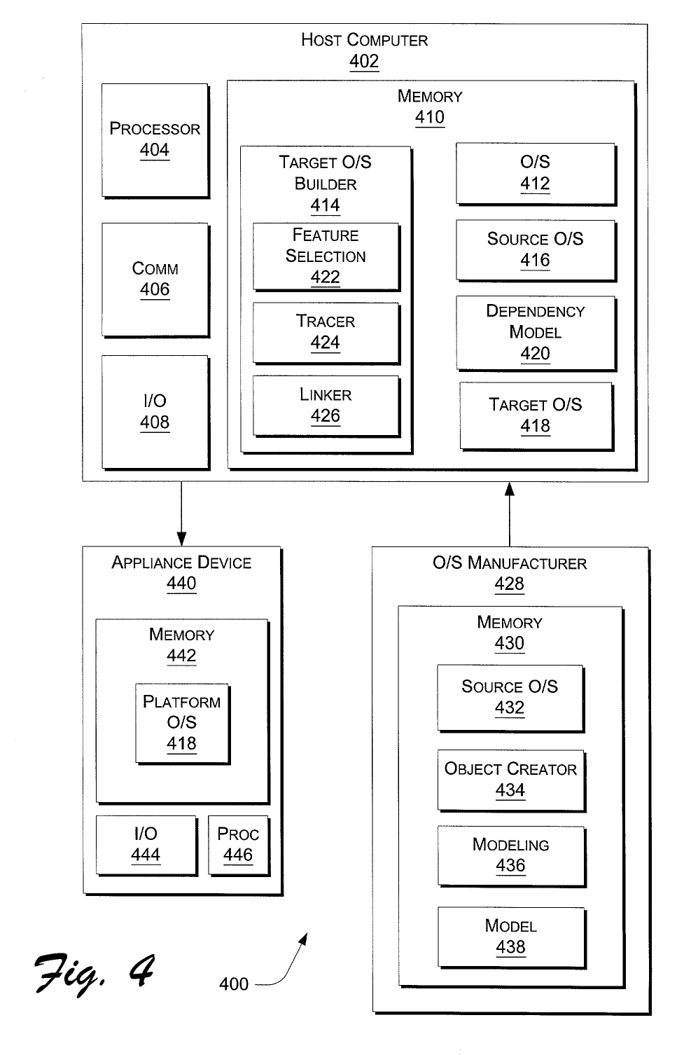

FIG. 4 shows an exemplary target operating building system 400 for constructing a target operating system for an embedded/applicant device from a source operating system. A host computer 402 includes a processor 404, a communications module 406, and input/output (I/O) module 408, and memory 410. The memory 410 stores an operating system 412, a target operating system builder program 414 and a source operating system 416. The operating system 412 is used to operate the host computer 402 and the source operating system 416 is an operating system containing all possible components from which a target operating system 418 may be built. The target operating system 418 is stored in the memory 410 as it is constructed. The memory 410 also stores a dependency model 420 that is used to construct the target operating system 418. The target operating system builder program 414 includes a feature selection module 422, a tracer 424 and a linker 426.

Also shown in FIG. 4 is an operating system (O/S) manufacturer 428. The O/S manufacturer 428 includes memory 430, which stores a source operating system 432, an object creator 434, a modeling module 436 and a dependency model 438. The object creator 434 is configured to create a data object for each component in the source operating system 432. The modeling module 436 utilizes the data objects to construct the dependency model 438. The source operating system 432 and the dependency model 438 are then transferred to the host computer 402 (as source operating system 416 and dependency model 420).

The target operating system 418, after being created on the host computer 402, is loaded into an appliance device 440. The appliance device 440 includes memory 442, an input/output module 444 and a processor 446. It is noted that the appliance device 440 is exemplary only, and that the appliance device 440 may be more complex than the appliance device 440 shown.

Continuing reference will be made to the features and reference numerals of FIG. 4 as the discussion of the methodological implementation of the target operating system building system 400 progresses.

I. Methodological Implementation of the Target O/S Builder System

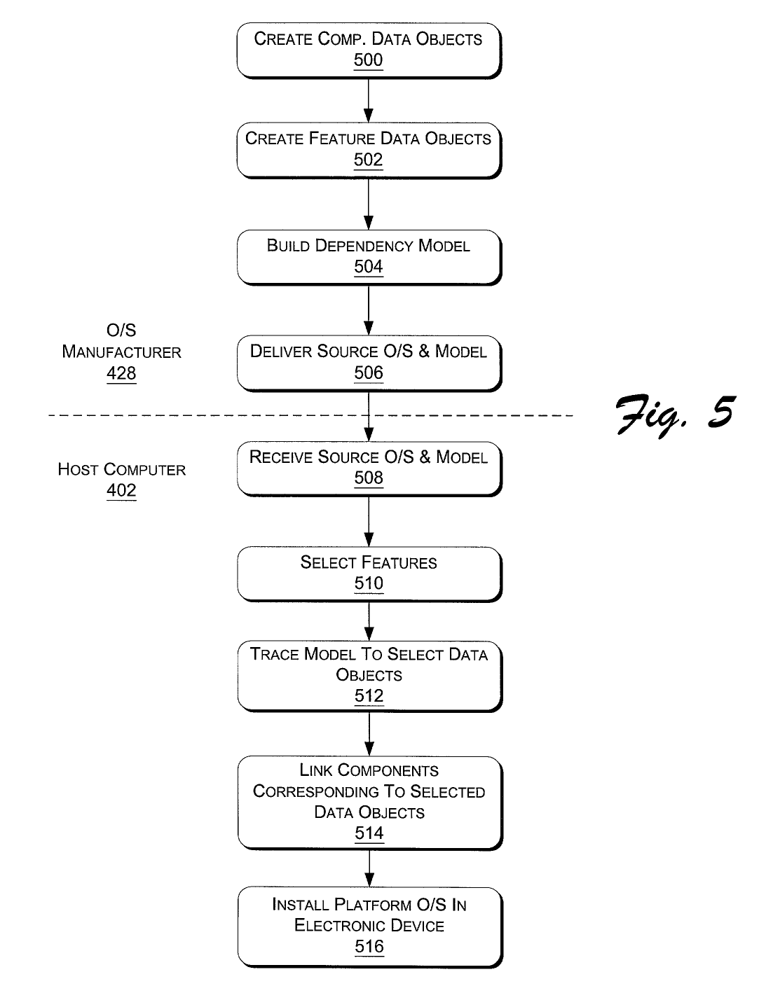

FIG. 5 shows a methodological implementation of the target operating system building system 400 shown in FIG. 4. This methodological implementation may be performed in software, hardware, or a combination thereof. Continuing reference will be made to the features and reference numerals of FIG. 4 in the discussion of FIG. 5.

The methodological implementation shown in FIG. 5 is shown in blocks representing acts that occur at the O/S manufacturer 428 and at the host computer 402. Blocks 500-506 will be shown as being performed at the O/S manufacturer 428. Blocks 508-516 are shown as being performed at the host computer 402. It is noted, however, that the delineation and distribution of the necessary tasks may be performed at either the host computer 402 or the O/S manufacturer 428, or at another unit. FIG. 5 merely depicts one implementation that may be used.

At block 500, data objects are created for each component in the source operating system 432 by the object creator 434 according to the Exports, Hard References, Soft References and Independent Links as described above. Data objects are also created for features and choices of the source operating system 432 (block 502). A data object created for an operating system feature may simply represent an operating system component or it may represent a set of components. The initial mapping of features to components may be accomplished in various ways and those skilled in the art will recognize the advantages and disadvantages of particular implementations.

At block 504, the modeling module 436 creates a dependency model 438 using the data objects created at block 500 and block 502. The source operating system 432 and the dependency model 438 are delivered to the host computer 402 at block 506. This may be accomplished by any known method, such as via the Internet, CD-ROM, floppy diskette, etc. Furthermore, the source operating system 432 and the dependency model 438 do not necessarily have to be delivered to the host computer 402 as long as the host computer 402 has access to the source operating system 432 and the dependency model 438.

At block 508, the host computer 402 receives the source operating system 432 and the dependency model 438 from the O/S manufacturer 428. The target operating system builder program 414 provides a user interface (not shown) through the feature selection module 422 to allow a user to select the desired features for the target operating system (block 510). Features may include, but are not limited to, a basic operating system kernel, file system, file system add-ons, device drivers, windows manager, graphics, communication protocol stacks, and the like. In one implementation, the user is provided with a menu from which the user may select desired features.

The tracer 424 identifies the selected features and traces the dependency model 420 to select the required data objects at block 512. When choice data objects are encountered, the tracer will need to determine which choice alternative has been selected. This determination may be made in a number of ways, including, but not limited to, prompting the user for an alternative or retrieving a previously selected alternative. Graph tracing and selection algorithms are well known in the art and any known method may be used to trace the Hard References to the Exports that resolve them and select the data object that contains the Export. After the data objects are selected, the linker 426 links the components represented by the selected data objects at block 514 to create the target operating system 418. At block 516, the target operating system 418 is installed in the memory 442 of the appliance device 440.

### II. Exporting the Functionality of the Target Operating System

A. Introduction

In addition to selecting the components of the target operating system, additional development files associated with the target operating system components will typically be required in order to export the functionality of the target operating system to a user or customer. The development files may include header files, library files, documentation files, auxiliary files and the like, that are required to utilize the target operating system and to create applications to run in conjunction with the target operating system.

As previously discussed, a target operating system is an example of a modularized system, i.e., a system that is made up of modules, or components. To enable developers to develop applications and programs to work with the modularized system, other files—development files—must be made available to the developers. The present invention addresses the problem of determining which development files should be made available with a customized modularized system. For purposes of the present discussion, an exportable unit referred to as a software development kit (“SDK”) is created that contains a modularized system and the development files necessary to support the modularized system. The SDK may be stored on one or more computer-readable media for distribution to developers.

It is noted that an SDK may typically exclude the modularized system and only include development files. However, for discussion purposes, the SDK described hereafter includes the modularized system as well as the development files.

B. Exemplary System

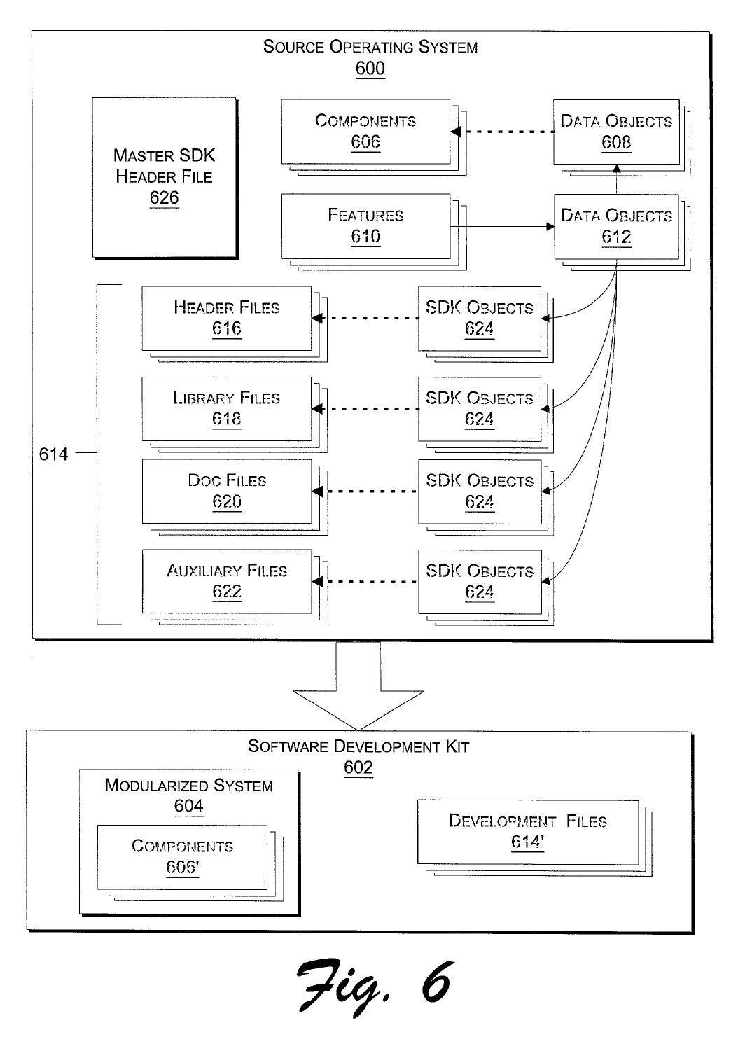

FIG. 6 is a simplified block diagram of a source operating system 600 and a software development kit 602 that includes a modularizes system 604 created from the source operating system 600. FIG. 6 will be used to discuss a general overview of the systems and methods described in more detail below.

The source operating system 600 includes several components 606 and data objects 608 associated with the components 606 in accordance with the above teachings. Also included in the source operating system 600 are one or more features 610 and data objects 612 associated with the features 610 as described previously. In addition, the source operating system 600 includes several development files 614 that include header files 616, library files 618, documentation files 620 and auxiliary files 622. Several SDK objects 624 are included in the source operating system 600, there being an SDK object 624 associated with each development file 614 of the source operating system 600.

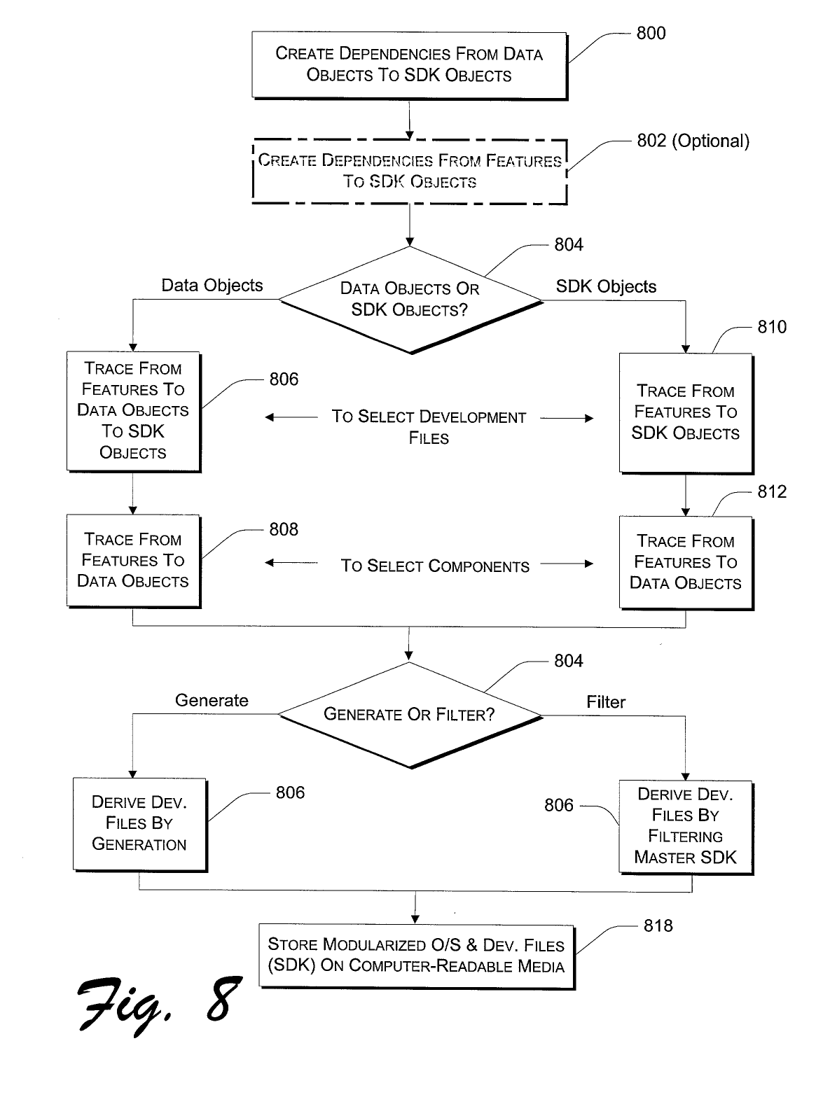

The source operating system 600 also shows selected development files 614′ which are the development files 614 that are selected for exporting to the SDK 602. A master SDK header file 626 is also included in the source operating system 600 and includes executable language to conditionally expose of the development files 614 for inclusion in the SDK 602. The master SDK header file 626 will be discussed in greater detail below, with respect to FIG. 8.

Each of the features 610 is associated with a data object 612. The data objects 612 that are associated with features 610 refer to one or more data objects 608 that correspond with one or more components 606. The data objects 612 that are associated with features 610 also refer to one or more SDK objects 624 that correspond to one or more development files 614.

In another implementation, the features 610 not only refer to the data objects 612, but also to SDK objects (not shown) corresponding to the features 610. In such an implementation, when a feature is selected, one or more SDK objects (not shown) are selected. The one or more SDK objects (not shown) reference the SDK objects 624 associated with the development files 614. Those skilled in the art will easily understand how such an implementation works without further discussion specifically regarding the implementation.

The SDK 602 includes the modularized system 604 which is made up of several components 606′ selected from the components 606 of the source operating system 600 in the manner described above. The modularized system 602 also includes several development files 614′ that comprise a subset of the development files 614 included in the source operating system 600. The development files 614′ may include any or all of the file types 616-622 included in the development files 614 of the source operating system 600. The SDK 602 forms a unit that can be distributed to users that allow the users to utilize the modularized system 604 and develop applications (not shown) for use with the modularized system 604.

It is noted that the following systems and methods may be practiced separately or together with the previously described systems and methods for building the modularized system, i.e., a target operating system. In one implementation, the target operating system may be created as described above. The resultant selected components (more particularly, the data objects associated with the selected components) may then be used to begin the process of identifying SDK objects and, subsequently, development files to include with the components.

In another implementation, the components of the target operating system may be selected in a separate process so that it is unnecessary to build the target operating system before creating an SDK that includes development files (i.e., the target operating system has already been constructed and the components are provided). In such an implementation, the features selected for the target operating system are identified and SDK objects associated with the features are used to identify development files to include in the final SDK.

C. Exemplary Data Structure: SDK Object

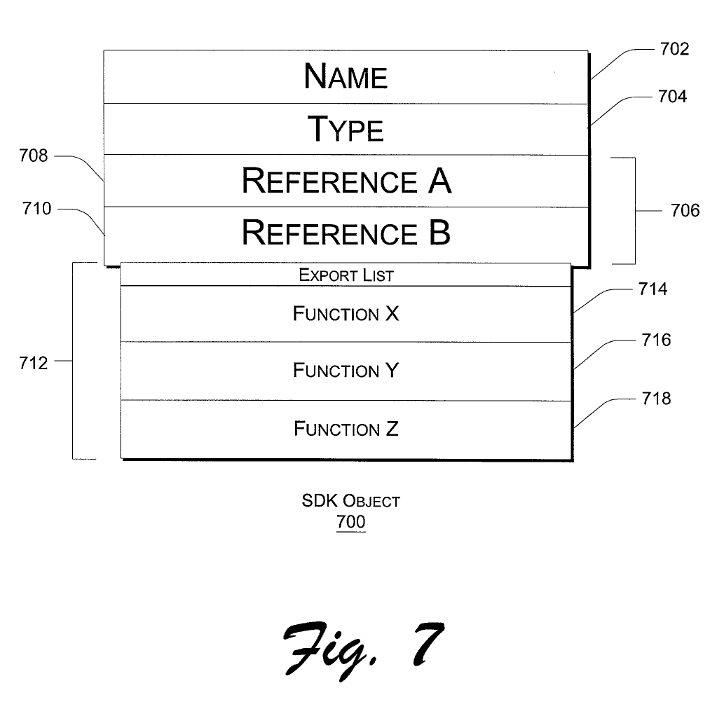

FIG. 7 is an illustration of an exemplary SDK object 700 constructed in accordance with the present invention. The SDK object 700 is somewhat similar to the exemplary data object 300 shown in FIG. 3, above, though certain differences are obvious. It should be noted that the SDK object 700 is a merely a data object 300 of type “SDK.”

The SDK object 700 includes a name field 702 and a type field 704. For purposes of the following discussion, all SDK objects are simply of type “SDK.” The SDK object 700 also includes a references field 706 that may contain one or more references 708, 710 to other SDK objects (not shown). The SDK object 700 also includes an export list 712 that identifies one or more functions (e.g., function X 714, function Y 716 and function Z 718) that are exposed by one or more data objects (not shown) associated with each of the references 708, 710.

It is noted that the functions 714-716 included in the export list 712 shown in FIG. 7 is exemplary only. The export list 712 may contain from one to virtually any number of functions. For discussion purposes, only the three functions 714-716 are shown.

It is undesirable to include development files associated with functions in the modularized system that are not exposed to end users. Therefore, as will be described in greater detail below, the export list 712 is used to determine the development files associated with components or functions that are to be included in the modularized system.

D. Methodological Implementation

1. Tracing/Selecting SDK Objects

FIG. 8 is a flow diagram depicting a methodological implementation of the described invention in the context of the exemplary system shown in FIG. 6. In the following discussion of FIG. 8, continuing reference will be made to the elements and reference numerals of FIG. 6 and FIG. 7.

At block 800, dependencies are created from data objects 612 that are associated with features 610 to SDK objects 624. When features 610 are selected, corresponding data objects 612 are selected. Other data objects 608 are traced through the selected data objects 612. In addition, since dependencies have been created from data objects 612 associated with features 610 to SDK objects 624, SDK objects 624 are traced through the data objects 612 selected when features are selected.

Block 802 is an optional step in which dependencies are created from features 610 to SDK objects 624 through special SDK objects (not shown) that correspond with the features 610. It is noted that, usually, only block 800or block 802will be performed. However, it is possible to perform both block 800 and block 802. For example, block 800 may be implemented for selecting a certain type of development file 614 (e.g., header files 616), and block 802 may be implemented for selecting the other types of development files 614.

Depending on whether special SDK objects (not shown) are created that are associated with feature 610 (“SDK Objects” branch, block 8 04), or SDK objects 624 are traced from data objects 608 associated with features 610 (“Data Objects” branch, block 804), different steps are performed. It is noted, however, that as previously discussed, it is possible to utilize both branches if different methods are used to select different types of development files 614.

If special SDK objects (not shown) associated with features 610 are not used (“Data Objects” branch, block 804), then SDK objects are traced as previously discussed (block 806) from the data objects 608 that are associated with selected features 610. Ultimately all SDK object references are resolved and the appropriate SDK objects 624 are selected. Data tracing is then performed from the selected features 610 to identify and select the components 606′ that comprise the modularized system 604 at block 808.

Alternatively, if special SDK objects (not shown) associated with features 610 are used (“SDK Objects” branch, block 804), then other SDK objects are traced from the features 610 to the special SDK objects (not shown) at block 810 and then to the SDK objects 624 associated with the development files 614. Data tracing is then performed from the selected features 610 to identify and select the components 606′ that comprise the modularized system 604 (block 812).

2. Generating SDK Development Files

At block 804, there are two options that can be used to select the development files to be included with the software development kit 602. The first option (“Generate” branch, block 804) derives the development files by generation (block 806). The second option (“Filter” branch, block 804) derives the development files by filtering the master SDK header file 626.

After the appropriate SDK objects 624 have been selected by the tracing process explained above, each function (714-718) contained in the export list 712 of each of the SDK objects 624 are processed. First, it is determined if the component 606′ (or function) associated with each export list function (714-718) has been included in the modularized system 604. If the component 606′ associated with an export list function (714-718) is not included in the modularized system 604, then the export list function (714-718) is ignored and processing continues with the next function (714-718) included in the export list 712. In a preferred implementation, determining if a component 606′ is included in the modularized system 604 is accomplished by examining the data objects 608 associated with the components 606.

If the component 606′ associated with an export list function (714-718) is included in the modularized system 604, then an SDK object 624 associated with the function (714-718) is selected and a development file 614 associated with the SDK object 624 is included in the selected development files 614′.

This process continues until all functions (714-718) of all SDK objects 624 have been processed. At the end of this process, the selected development files 614′ are complete and ready to export. The export process will be explained in greater detail below.

3. Filtering A Master SDK File

Instead of generating the selected development files 614′ as described above, another option is to generate the selected development files 614′ by filtering the master SDK header file 626 (block 806). The master SDK header file 626 includes code language that conditionally exposes each of the development files for inclusion in the SDK 602. For example, assume that SDK objects 624 associated with the following development files 614 have been selected by the tracing process explained above: alpha.h, beta.h, alpha.doc, and alpha.lib. Then assume that the SDK master header file 626 includes code similar to the following pseudo code:

```
if
  alpha.h is selected
then
  copy alpha.h into the selected development files
endif
if
  alpha.doc is selected
then
  copy alpha.doc into the selected development files
  endif
if
  alpha.lib is selected
then
  copy alpha.lib into the selected development files
endif
if
  beta.h is selected
then
  copy beta.h into the selected development files
endif
if
  beta.doc is selected
then
  copy beta.doc into the selected development files
endif
if
  delta.h is selected
then
  copy delta.h into the selected development files
endif
```

When the code in the master SDK header file 626 is executed, the files alpha.h, beta.h, alpha.doc, and alpha.lib will be included in the SDK 602. The files beta.doc and delta.h would not be included in the SDK 602 because the SDK objects 624 associated with these files were not selected.

Those skilled in the art will recognize the generality of the above-stated pseudo code and the variations that may be available to implement the described invention. For example, the ‘copy’ statements included above may not actually entail copying a file into the final SDK. In fact, the ‘copy’ statements may read more like “find a *.* label in a master header file and enable the section of code associated with the label” where enabling the code associated with the label in some way includes the development file (*.*) in the SDK.

After the SDK master header file 626 has finished processing, the selected development files 614′ are complete and ready to export. The export process will be explained in greater detail below.

4. Exporting the SDK

At block 808, the modularized system 604 (i.e., the components 606′ that make up the modularized system 604) and the selected development files 614′ are stored on one or more computer-readable media (not shown) to create the SDK 602. For example, the modularized system 604 and the development files 614′ may be stored on one or more CD-ROM disks. The CD-ROM disks can then be mass produced for distribution to customers (i.e., developers).

### III. Exemplary Computing System and Environment

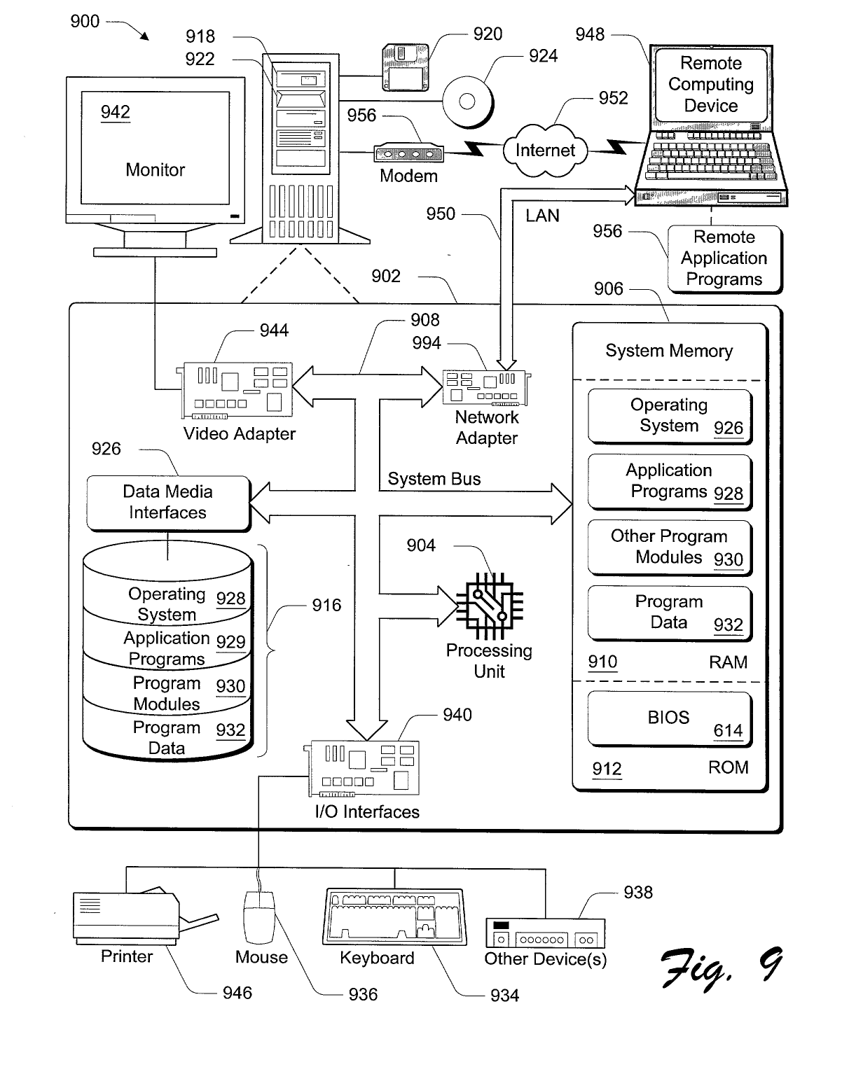

FIG. 9 illustrates an example of a suitable computing environment 900 within which an exemplary target operating system building system, as described herein, may be implemented (either fully or partially). The computing environment 900 may be utilized in the computer and network architectures described herein.

The exemplary computing environment 900 is only one example of a computing environment and is not intended to suggest any limitation as to the scope of use or functionality of the computer and network architectures. Neither should the computing environment 900 be interpreted as having any dependency or requirement relating to any one or combination of components illustrated in the exemplary computing environment 900.

The exemplary target operating system building system may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Exemplary audio recognizer may be described in the general context of computer-executable instructions, such as program modules, being executed by a computer. Generally, program modules include routines, programs, objects, components, data structures, etc. that perform particular tasks or implement particular abstract data types. The exemplary system may also be practiced in distributed computing environments where tasks are performed by remote processing devices that are linked through a communications network. In a distributed computing environment, program modules may be located in both local and remote computer storage media including memory storage devices.

The computing environment 900 includes a general-purpose computing device in the form of a computer 902. The components of computer 902 can include, by are not limited to, one or more processors or processing units 904, a system memory 906, and a system bus 908 that couples various system components including the processor 904 to the system memory 906.

The system bus 908 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 902 typically includes a variety of computer readable media. Such media can be any available media that is accessible by computer 902 and includes both volatile and non-volatile media, removable and non-removable media.

The system memory 906 includes computer readable media in the form of volatile memory, such as random access memory (RAM) 910, and/or non-volatile memory, such as read only memory (ROM) 912. A basic input/output system (BIOS) 914, containing the basic routines that help to transfer information between elements within computer 902, such as during start-up, is stored in ROM 912. RAM 910 typically contains data and/or program modules that are immediately accessible to and/or presently operated on by the processing unit 904.

Computer 902 may also include other removable/non-removable, volatile/non-volatile computer storage media. By way of example, FIG. 9 illustrates a hard disk drive 916 for reading from and writing to a non-removable, non-volatile magnetic media (not shown), a magnetic disk drive 918 for reading from and writing to a removable, non-volatile magnetic disk 920 (e.g., a “floppy disk”), and an optical disk drive 922 for reading from and/or writing to a removable, non-volatile optical disk 924 such as a CD-ROM, DVD-ROM, or other optical media. The hard disk drive 916, magnetic disk drive 918, and optical disk drive 922 are each connected to the system bus 908 by one or more data media interfaces 926. Alternatively, the hard disk drive 916, magnetic disk drive 618, and optical disk drive 922 can be connected to the system bus 908 by one or more interfaces (not shown).

The disk drives and their associated computer-readable media provide non-volatile storage of computer readable instructions, data structures, program modules, and other data for computer 902. Although the example illustrates a hard disk 916, a removable magnetic disk 920, and a removable optical disk 924, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 916, magnetic disk 920, optical disk 924, ROM 912, and/or RAM 910, including by way of example, an operating system 928, one or more application programs 629, other program modules 630, and program data 632. Each of such operating system 628, one or more application programs 629, other program modules 630, and program data 632 (or some combination thereof) may include an embodiment of a target operating system building component and/or a modularized system exporting component.

A user can enter commands and information into computer 902 via input devices such as a keyboard 934 and a pointing device 936 (e.g., a “mouse”). Other input devices 938 (not shown specifically) may include a microphone, joystick, game pad, satellite dish, serial port, scanner, and/or the like. These and other input devices are connected to the processing unit 904 via input/output interfaces 940 that are coupled to the system bus 908, but may be connected by other interface and bus structures, such as a parallel port, game port, or a universal serial bus (USB).

A monitor 942 or other type of display device can also be connected to the system bus 908 via an interface, such as a video adapter 944. In addition to the monitor 942, other output peripheral devices can include components such as speakers (not shown) and a printer 946 which can be connected to computer 902 via the input/output interfaces 940.

Computer 902 can operate in a networked environment using logical connections to one or more remote computers, such as a remote computing device 948. By way of example, the remote computing device 948 can be a personal computer, portable computer, a server, a router, a network computer, a peer device or other common network node, and the like. The remote computing device 948 is illustrated as a portable computer that can include many or all of the elements and features described herein relative to computer 902.

Logical connections between computer 902 and the remote computer 948 are depicted as a local area network (LAN) 950 and a general wide area network (WAN) 952. Such networking environments are commonplace in offices, enterprise-wide computer networks, intranets, and the Internet.

When implemented in a LAN networking environment, the computer 902 is connected to a local network 950 via a network interface or adapter 954. When implemented in a WAN networking environment, the computer 902 typically includes a modem 956 or other means for establishing communications over the wide network 952. The modem 956, which can be internal or external to computer 902, can be connected to the system bus 908 via the input/output interfaces 940 or other appropriate mechanisms. It is to be appreciated that the illustrated network connections are exemplary and that other means of establishing communication link(s) between the computers 902 and 948 can be employed.

In a networked environment, such as that illustrated with computing environment 900, program modules depicted relative to the computer 902, or portions thereof, may be stored in a remote memory storage device. By way of example, remote application programs 958 reside on a memory device of remote computer 948. For purposes of illustration, application programs and other executable program components such as the operating system are illustrated herein as discrete blocks, although it is recognized that such programs and components reside at various times in different storage components of the computing device 902, and are executed by the data processor(s) of the computer.

Computer-Executable Instructions

An implementation of a system and or method for exporting the functionality of a modularized system may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 9 illustrates an example of a suitable operating environment 900 in which a system and/or method of exporting the functionality of a modularized system may be implemented. Specifically, the systems and methods described herein may be implemented (wholly or in part) by any program modules 929-932 and/or operating system 928 in FIG. 9 or a portion thereof.

The operating environment is only an example of a suitable operating environment and is not intended to suggest any limitation as to the scope or use of functionality of the systems and methods described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Computer-Readable Media

An implementation of a system and/or method for exporting the functionality of a modularized system may be stored on or transmitted across some form of computer readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

### IV. Exemplary System for Exporting Functionality of a Modularized Sys.

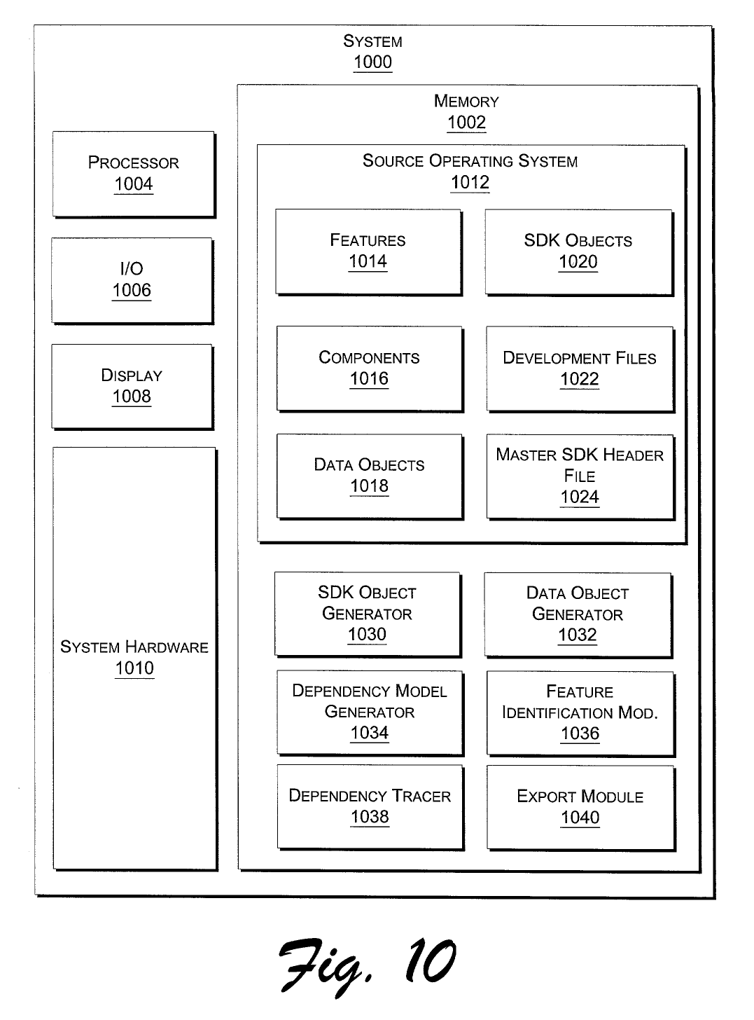

FIG. 10 is a block diagram of an exemplary system 1000 for exporting the functionality of a modularized system constructed in accordance with the present invention. The system 1000 includes memory 1002, a processor 1004, an input/output (I/O) device 1006, a display 1008, and system hardware 1010 necessary to support the features of the system 1000.

The memory 1002 stores a source operating system 1012 that includes selectable features 1014 that are features available in the source operating system 1012. The features 1014 are displayable to a user on the display 1008 so that a user may select particular operating system features to include in a modularized system. The source operating system 1012 also includes components 1016, data objects 1018, SDK objects 1020, development files 1022 and a master SDK header file 1024. All of the modules in the source operating system 1012 are as previously described.

The memory 1002 also stored an SDK object generator 1026 which is configured to create the SDK objects 1020, a data object generator 1028 which is configured to create the data objects 1030 and a dependency model generator 1032 which is configured to create a dependency model. These memory modules function to allow a user to create objects and trace through the objects to determine necessary components, as described above.

The memory 1002 also stores a feature identification module 1034 which is configured to present the features 1004 of the source operating system 1012 to a user so that the user may select desired features. Also included in the memory 1002 are a dependency tracer 1036 and a linker 1038. The dependency tracer 1036 operates to trace data objects 1018 and SDK objects 1020 as described above. The linker 1038 is used in the process of creating the selected development files 614′ as described above.

It is noted that the elements of the system 1000 shown in FIG. 10 are somewhat arbitrary in that certain functions described above may be confined to a specific elements or may cross the boundaries of specific elements. However, this is related to an implementation detail and those skilled in the art will recognize the functions that must be included in specific elements of the system 1000.

Conclusion

Using the systems and methods described herein, a developer can derive a specialized operating system from a source operating system and export an SDK to application developers who may then develop application to run on the specialized operating system. The developer does not have to export more than what is absolutely needed and thus can reduce storage overhead and expense. In addition, exporting the minimum amount of code possible protects the developer from misuse or misappropriation of components that the developer does not want to publicly expose.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
creating a software development kit object (SDK object) for at least some of a plurality of development files in a source operating system that includes development files and components;
identifying features of the source operating system to be included in a modularized system that is a subset of the source operating system;
tracing dependencies in a dependency model correlating to the source operating system that uses the SDK objects to identify SDK objects corresponding to development files that are required to support the identified features;
selecting the development files that correspond to the identified SDK objects; and
exporting the selected development files to a software development kit (SDK) that supports development of applications for use with the modularized system.

2. The method as recited in claim Error! Reference source not found., wherein the modularized system is a modularized system that includes a subset of development files and components of the source operating system.

3. The method as recited in claim Error! Reference source not found., further comprising generating the dependency model using the SDK objects.

4. The method as recited in claim Error! Reference source not found., further comprising generating the dependency model by:
identifying dependencies between development files;
creating SDK objects for the development files; and
for all the development files, if a first development file depends on a second development file, including a reference in a first SDK object associated with the first development file to a second SDK object associated with the second development file.

5. The method as recited in claim Error! Reference source not found., wherein the development files further comprise at least one or more of the following types of files: library files, documentation files, header files.

6. The method as recited in claim Error! Reference source not found., wherein the tracing dependencies further comprises tracing references from a first SDK object associated with a feature to at least a second SDK object and, if the second SDK object includes a reference to a third SDK object, tracing the reference to the third SDK object.

7. The method as recited in claim Error! Reference source not found., wherein the tracing dependencies further comprises:
identifying a data object associated with each identified feature, the data object being associated with a component of the source operating system; and
if a data object includes a reference to a first SDK object, tracing the reference to the first SDK object and tracing references, if any, from the first SDK object to a second SDK object.

8. The method as recited in claim Error! Reference source not found., wherein creating the SDK objects further comprises:
naming a data object having a type that identifies the data object as being an SDK object;
including at least one reference in a first SDK object, the reference pointing to a second SDK object that is required by the first SDK object to function properly; and
repeating the previous steps for each development file to be exposed in the SDK.

9. The method as recited in claim 8, further comprising including an export list in the first data object that identifies one or more functions that may be exposed by the development file associated with the SDK object.

10. The method as recited in claim Error! Reference source not found., wherein the tracing dependencies in a dependency model further comprises tracing dependencies beginning with a first set of SDK objects that are associated with the features to subsequent sets of SDK objects on which the first set of SDK objects depend.

11. The method as recited in claim Error! Reference source not found., wherein the tracing dependencies in a dependency model further comprises:
tracing dependencies beginning with data objects that are associated with the features, the data objects having references to one or more SDK objects in a first set of SDK objects, the first set of SDK objects having one or more reference to one or more SDK objects in a second set of SDK objects; and
wherein the first set of SDK objects depend on the second set of SDK objects for the first set of SDK objects to function.

12. The method as recited in claim Error! Reference source not found., wherein the exporting further comprises storing the selected development files on one or more computer-readable media.

13. One or more computer-readable media containing computer-executable instructions that, when executed on a computer, perform the following steps:
selecting one or more developmental files associated with a source operating system that required to support features selected for a modularized system that is a subset of the source operating system by tracing a dependency model that includes SDK objects associated with the one or more development files; and
exporting the selected development files to a software development kit (SDK).

14. The one or more computer-readable media as recited in claim 13, wherein the selecting one or more development files further comprises:
selecting one or more features of the source operating system to be included in the modularized system, each of the one or more features having a data object associated therewith;
tracing dependencies from the data objects to software development kit (SDK) objects that are associated with development files in order to identify SDK objects that are associated with development files to be included in a software development kit associated with the modularized system; and
selecting a development file that is associated with an identified SDK object.

15. The one or more computer-readable media as recited in claim 13, wherein the selecting one or more development files further comprises:
selecting one or more features of the source operating system to be included in the modularized system, each of the one or more features having a software development kit object (SDK object) associated therewith;
tracing dependencies from the SDK objects associated with the features to SDK objects that are associated with development files in order to identify SDK objects that are associated with development files to be included in a software development kit associated with the modularized system; and
selecting a development file that is associated with an identified SDK object

16. The one or more computer-readable media as recited in claim 13, further comprising creating the dependency model by creating the SDK objects to model dependencies between the development files associated with the SDK objects.

17. The one or more computer-readable media as recited in claim 16, wherein the creating the SDK objects further comprises:
for each development file in the source operating system that may be included in the modularized system, identifying a data object as being an SDK object that corresponds to a development file;
if a first development file associated with an SDK object requires the presence of a second development file to function properly, including a reference in a first SDK object associated with the first development file to a second SDK object.

18. The one or more computer-readable media as recited in claim 13, wherein the development files are of one or more of the following types of files: header files; library files; and/or documentation files.

19. A method, comprising:
identifying features in a source operating system to be included in a modularized system;
selecting development files to be included in an SDK by tracing dependencies in a dependency model beginning with data objects associated with the identified features; and
exporting the selected development files; and
wherein the development files are files required to support development of applications to work with the modularized system.

20. The method as recited in claim 19, further comprising generating the dependency model using the SDK objects.

21. The method as recited in claim 19, further comprising:
identifying dependencies between development files;
creating SDK objects for at least some of the development files;
for all development files that have an SDK object associated with it, if a first development file depends on a second development file, including a reference in a first SDK object associated with the first development file to a second SDK object associated with the second development file; and
wherein the identifying and creating generates the dependency model, and the selecting development files further comprises tracing references in SDK objects to determine the development files to select.

22. The method as recited in claim 19, wherein the development files include one or more of the following types of files: header files; library files; and/or documentation files.

23. The method as recited in claim 19, wherein the exporting further comprising outputting the selected development files to one or more computer-readable medium.

24. The method as recited in claim 19, further comprising generating the dependency model utilizing the SDK objects.

25. One or more computer-readable media containing computer-executable instructions that, when executed on a computer, perform the following steps:
selecting one or more software development kit objects (SDK object), each SDK object being associated with a developmental file in a source operating system that is required to support one or more features of the source operating system selected for inclusion in a modularized system that is a subset of the source operating system; and
filtering a master SDK header file to determine developmental files to include with a software development kit (SDK) that is used with the modularized system to allow software to be developed to work with the modularized system.

26. The one or more computer-readable media as recited in claim 25, wherein the filtering further comprises:
for each selected SDK object, searching for a label in the master SDK header file that is the same name as the SDK object;
if the label is found, enabling a section of code associated with the label; and
wherein the enabling the section of code associated with the label enables the appropriate development file associated with the SDK object to be included in the SDK.

27. The one or more computer-readable media as recited in claim 25, wherein the filtering further comprises:
executing the master SDK header file that includes labels that are the same names as the SDK objects, each of the labels being associated with a section of code;
when encountering a label, determining of an SDK object of the same name as the label has been selected for inclusion in the SDK;
if the SDK object has been selected, enabling the section of code associated with the label;
wherein the section of code associated with the label enables the appropriate development file associated with the SDK object to be included in the SDK.

28. The one or more computer-readable media as recited in claim 25, wherein the development files further comprise one or more of the following types of files: library files; header files; and/or documentation files.

29. The one or more computer-readable media as recited in claim 25, wherein the selecting one or more SDK objects further comprises:
tracing SDK object dependencies using a dependency model, the tracing being from one or more data objects associated with the selected features to one or more SDK objects; and
selecting each SDK object encountered in the tracing process.

30. The one or more computer-readable media as recited in claim 29, wherein the data objects associated with the features are SDK objects.

31. The one or more computer-readable media as recited in claim 29, wherein the data objects associated with the features also reference data objects associated with one or more components of the source operating system.

32. The one or more computer-readable media as recited in claim 25, further comprising exporting the developmental files derived from filtering the master SDK header file.

33. The one or more computer-readable media as recited in claim 32, wherein the exporting further comprises storing the developmental files on one or more computer-readable media.

34. A system, comprising:
an SDK object generator configured to generate one or more SDK objects, each SDK object being associated with a development file of a source operating system;
a feature identification module that can be used to select desired features from the source operating system to be included in a modularized system that is a subset of the source operating system;
a dependency tracer configured to trace references from data objects associated with the selected features to identify SDK objects associated with the development files required to support the selected features; and
an export module configured to export the development files associated with the identified SDK objects.

35. The system as recited in claim 34, wherein the SDK object generator is further configured to allow generation of a first SDK object that includes at least one reference to a second SDK object if a first development file associated with the first SDK object depends on the availability of a second development file associated with the second SDK object.

36. The system as recited in claim 35, wherein the SDK generator is further configured to allow generation of an SDK object that includes an export list that contains the names of functions of the source operating system, if any, that are exposed by the SDK object.

37. The system as recited in claim 34, wherein the data objects associated with the selected features are data objects that also reference components of the source operating system.

38. The system as recited in claim 34, wherein the data objects associated with the selected features are SDK objects.

39. The system as recited in claim 34, wherein the development files further comprise one or more files of the following types: header files; documentation files; and/or library files.

40. The system as recited in claim 34, wherein the export module is further configured to transmit the selected development files to one or more computer-readable media where the development files are stored.

41. The system as recited in claim 40, wherein the development files are stored in a software development kit.
